(19) United States
(12) Patent Application Publication
(10) Pub. No.: US 2024/0379981 A1
(43) Pub. Date: Nov. 14, 2024

(54) METHODS AND SYSTEMS FOR PROCESSING ELECTROCHEMICAL SYSTEM FUEL EXHAUST

(71) Applicant: BLOOM ENERGY CORPORATION, San Jose, CA (US)

(72) Inventors: David WEINGAERTNER, Sunnyvale, CA (US); Martin PERRY, Mountain View, CA (US); K.R. SRIDHAR, Los Gatos, CA (US)

(21) Appl. No.: 18/660,421

(22) Filed: May 10, 2024

Related U.S. Application Data
(60) Provisional application No. 63/465,503, filed on May 10, 2023.

(51) Int. Cl. H01M 8/0662; C01B 3/12; C25B 1/04; C25B 1/23; H01M 8/04014; H01M 8/04119; H01M 8/04225; H01M 8/12; H01M 8/2425

(52) U.S. Cl. CPC H01M 8/0681; C01B 3/12; C25B 1/04; C25B 1/23; H01M 8/04014; H01M 8/04156; H01M 8/04225; H01M 8/0662; H01M 8/2425; C01B 2203/0283; C01B 2203/067; H01M 2008/1293

(57) ABSTRACT

A method includes operating a fuel cell system to generate power and an anode exhaust, separating water and carbon dioxide in the anode exhaust from syngas consisting essentially of a mixture of hydrogen and carbon monoxide, and providing the syngas to a syngas user.

### FIELD

Aspects of the present invention relate to electrochemical systems, such as fuel cell systems, and more specifically to methods of generating and processing the fuel exhaust of the electrochemical system in order to generate a product, such as syngas.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as solid oxide regenerative fuel cells, that also allow reversed operation, such that oxidized fuel can be reduced back to unoxidized fuel using electrical energy as an input.

### SUMMARY

According to various embodiments, a method of operating a fuel cell system comprises operating the fuel cell system in a start-up mode, and operating the fuel cell system in a steady state mode after the step of operating the fuel cell system in the start-up mode. During the step of operating the fuel cell system in the steady-state mode, the fuel cell system cycles between operating in an exhaust export mode and in a thermal recovery mode a plurality of times. During the exhaust export mode, an anode exhaust generated by fuel cells of the fuel cell system is provided to an exhaust processing system, and no anode exhaust is provided to an anode tailgas oxidizer (ATO). During the thermal recovery mode, at least a portion of the anode exhaust is provided to the ATO.

According to various embodiments, a method comprises operating a fuel cell system to generate power and an anode exhaust; separating water and carbon dioxide in the anode exhaust from syngas consisting essentially of a mixture of hydrogen and carbon monoxide; and providing the syngas to a syngas user.

According to various embodiments, an apparatus comprises a fuel cell system; an exhaust processing system; and at least one anode exhaust conduit fluidly connecting an anode exhaust of the fuel cell system to an inlet of the exhaust processing system, wherein the exhaust processing system is configured to separate water and carbon dioxide in an anode exhaust of the fuel cell system from syngas consisting essentially of a mixture of hydrogen and carbon monoxide, and to provide the syngas to a syngas user.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1 is a schematic representation of a fuel cell power module, according to various embodiments of the present disclosure.

FIG. 2 is a schematic view of an exhaust processing system, according to various embodiments of the present disclosure.

FIG. 3 is a schematic view of an alternative exhaust processing systems, according to various embodiments of the present disclosure.

FIG. 4 is a schematic view of another alternative exhaust processing system, according to various embodiments of the present disclosure.

FIG. 5 is a schematic view of another alternative exhaust processing system, according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Solid oxide fuel cell (SOFC) systems may be operated using a hydrocarbon fuel, such as natural gas, methane, propane, etc., or a non-hydrocarbon fuel such as hydrogen (H₂) or ammonia. Anode exhaust generated by a SOFC system may include carbon dioxide and water, along with relatively small amounts of hydrogen, nitrogen (N₂), and carbon monoxide (CO). If the SOFC system is operated on ammonia fuel, then the anode exhaust may contain ammonia.

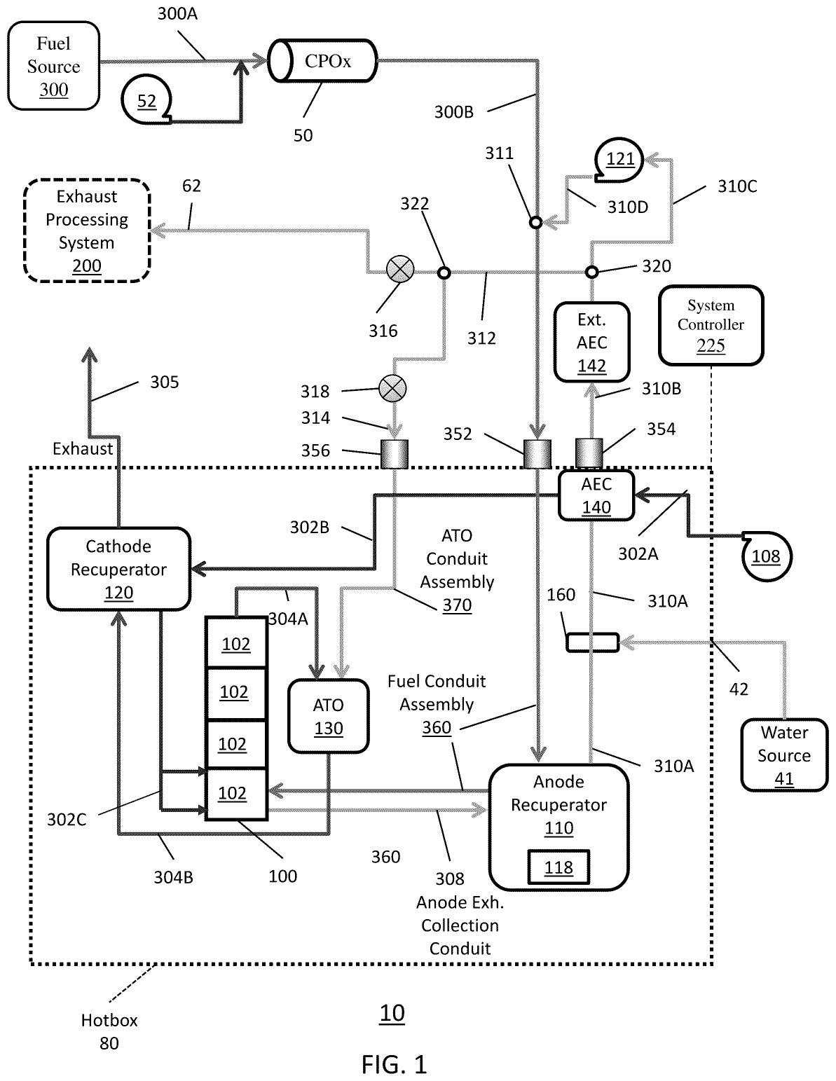

FIG. 1 is a schematic representation of a SOFC system power module 10, according to various embodiments of the present disclosure. Referring to FIG. 1, the power module 10 includes a hotbox 80 and various components disposed therein or adjacent thereto. The hotbox 80 may contain at least one fuel cell column 100 including one or more fuel cell stacks 102, such as one or more SOFC stacks containing alternating fuel cells and interconnects. One solid oxide fuel cell contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects.

The hotbox 80 may also contain an anode recuperator heat exchanger 110, a cathode recuperator heat exchanger 120, an anode tail gas oxidizer (ATO) 130, an anode exhaust cooler heat exchanger 140, and an optional water injector 160. The power module 10 may also include a catalytic partial oxidation (CPOx) reactor 50, a CPOx blower 52 (e.g., a CPOx air blower), a system blower 108 (e.g., system air blower), and an anode recycle blower 121, which may be disposed outside of the hotbox 80. However, the present disclosure is not limited to any particular location for each of the components with respect to the hotbox 80.

The CPOx reactor 50 receives a fuel inlet stream from a fuel source 300 through a fuel conduit 300A. The fuel source 300 may be a fuel tank or a utility natural gas line including a valve to control an amount of fuel provided to the CPOx reactor 50. The CPOx blower 52 may provide air to the CPOx reactor 50 during system start-up. The fuel and/or air output from the CPOx reactor 50 may be provided by a fuel conduit 300B to fuel inlet 352 of a fuel conduit assembly 360. The fuel inlet 352 may be located in a wall of the hotbox 80. Fuel flows through the fuel conduit assembly 360 to the anode recuperator 110. The fuel is heated in the anode recuperator 110 by the anode exhaust (i.e., fuel exhaust of the fuel cell column 100) and the fuel then flows from the anode recuperator 110 to the fuel cell column 100 through the fuel conduit assembly 360.

The system blower 108 may be configured to provide an air stream (e.g., air inlet stream) to the anode exhaust cooler 140 through a first air conduit 302A. Air flows from the anode exhaust cooler 140 to the cathode recuperator 120 through a second air conduit 302B. The air is heated by the ATO 130 exhaust in the cathode recuperator 120. The air flows from the cathode recuperator 120 to the fuel cell column 100 through a third air conduit 302C.

An anode exhaust (e.g., fuel exhaust stream) generated in the fuel cell column 100 is provided to the anode recuperator 110 through anode exhaust collection conduit 308. The anode exhaust may contain unreacted fuel and may also be referred to herein as fuel exhaust. The anode exhaust may be recycled from the anode recuperator 110 to fuel conduit 300B by one or more recycling conduits, in order to mix the anode exhaust with incoming fresh fuel in the fuel conduit 300A. The one or more recycling conduits may include plural recycling conduits 310A-310D. First recycling conduit 310A may fluidly connect an outlet of the anode recuperator 110 to an inlet of the anode exhaust cooler 140. The second recycling conduit 310B may fluidly connect an outlet of the anode exhaust cooler 140 located in the hotbox 80 via an anode exhaust outlet 354 of the hotbox 80 to an inlet of an optional secondary anode exhaust cooler heat exchanger 142 located outside the hotbox 80. The third recycling conduit 310C may fluidly connect an outlet of the secondary anode exhaust cooler 142 to an inlet of an anode recycle blower 121. The fourth recycling conduit 310D may fluidly connect an outlet of the anode recycle blower 121 to the fuel conduit 300B at the mixer 311, where the anode exhaust mixes with the incoming fresh fuel.

The secondary anode exhaust cooler 142 may be, for example, a finned radiator or heat exchanger disposed outside of the hotbox 80. The secondary anode exhaust cooler 142 may be configured to cool the anode exhaust output from the hotbox 80 to protect the anode recycle blower 121 from thermal stress and/or damage. In some embodiments, the hotbox 80 may be disposed in a module cabinet (i.e., power module housing), and the secondary anode exhaust cooler 142 may be configured to cool the anode exhaust using ventilation air flowing through the module cabinet. One or more fans or blowers may be located in the module cabinet to provide the ventilation air.

Water flows from a water source, such as a water tank or a water pipe 41, to the water injector 160 through a water conduit 42. The water injector 160 may be configured to inject water into anode exhaust flowing through the first recycling conduit 310A. Heat from the anode exhaust vaporizes the water to generate steam which humidifies the anode exhaust. The humidified anode exhaust is then provided to the anode exhaust cooler 140. Heat from the anode exhaust provided to the anode exhaust cooler 140 may be transferred to the air inlet stream provided from the system blower 108 to the cathode recuperator 120. The cooled humidified anode exhaust may then be provided from the anode exhaust cooler 140 to the optional secondary anode exhaust cooler 142 via the second recycling conduit 310B. The anode exhaust may then be provided to the anode recycle blower 121 by the third recycling conduit 310C, before being provided to fuel conduit 300B by fourth recycling conduit 310D.

The power module 10 may also include one or more fuel reforming catalysts 118 located inside and/or downstream of the anode recuperator 110. The reforming catalyst(s) partially reform the humidified fuel mixture before it is provided to the fuel cell column 100.

Cathode (e.g., air) exhaust generated in the fuel cell column 100 is provided to the ATO 130 by a first cathode exhaust conduit 304A. The ATO exhaust flows from the ATO 130 to the cathode recuperator 120, through the second cathode exhaust conduit 304B. The ATO exhaust flows from the cathode recuperator 120 and out of the hotbox 80 through the cathode exhaust conduit 305.

The power module 10 may further include a system controller 225 configured to control various elements of the power module 10. The system controller 225 may include a central processing unit configured to execute stored instructions. For example, the system controller 225 may be configured to control fuel and/or air flow through the power module 10, according to fuel composition data.

Carbon dioxide may be separated from the anode exhaust and captured in an exhaust processing system 200, which may be located inside or outside the power module cabinet. For example, anode exhaust may contain about 54 mol % water, most of which can be removed using a condenser. A remaining dry content of anode exhaust may include about 62 mol % CO₂, 25 mol % H₂, 12 mol % CO and 1 mol % N₂.

In prior SOFC systems, anode exhaust may be routed directly to the ATO using an ATO injector and/or conduits disposed within the system hotbox 80. However, when the anode exhaust is routed outside of the hotbox 80, such as when anode exhaust is provided to an exhaust processing system 200, conduits used to return the anode exhaust to the ATO 130 may significantly restrict the flow of the anode exhaust. In particular, the present inventors determined that space constraints within a hotbox may limit the size of such conduits, resulting in a significant system pressure drop.

Accordingly, the power module 10 may include a bypass conduit 312, a return conduit 314, a processing conduit 62, a bypass valve 316, a return valve 318 (e.g., ATO valve), a first splitter 320 and a second splitter 322. The bypass conduit 312 and the processing conduit 62 may fluidly connect the third recycling conduit 310C to the exhaust processing system 200. The inlet of the bypass conduit 312 may be fluidly connected to the third recycling conduit 310C at the first splitter 320. The outlet of the bypass conduit 312 may be fluidly connected to the inlets of the processing conduit 62 and the return conduit 314 at the second splitter 322. It should be noted that in an alternative embodiment, the bypass conduit 312 and the first splitter 320 may be omitted, and the processing conduit 62 and the return conduit 314 may be connected directly to the third recycling conduit 310C at the first splitter 320.

The return conduit 314 may fluidly connect the bypass conduit 312 to the anode exhaust inlet 356 of the hotbox 80. The ATO conduit assembly 370 may fluidly connect the anode exhaust inlet 356 to the ATO 130. The bypass valve 316 is located on the processing conduit 62 and is configured to control anode exhaust flow through the processing conduit 62. The return valve 318 is located on the return conduit 314 and is configured to control the anode exhaust flow through the return conduit 314. The valves 316, 318 may be electrically operated valves, such as solenoid valves or the like. Alternatively, the two valves 316, 318 and the second splitter 322 may be replaced by a single three-way valve which controls the relative amounts of anode exhaust flowing through the processing conduit 62 and the return conduit 314.

In the embodiment shown in FIG. 1, the bypass conduit 312 is fluidly connected to the second recycling conduit 310B upstream of the recycle blower 121, with respect to an anode exhaust flow direction through the third recycling conduit 310C. In an alternative embodiment, the bypass conduit 312 may be fluidly connected to the fourth recycling conduit 310D, downstream of the anode recycle blower 121, in order to provide additional anode exhaust flow pressure through the bypass conduit 312.

Locating the bypass valve 316 and the return valve 318 outside of the hotbox 80 may provide the benefit of protecting the valves 316, 318 from damage due to exposure to high temperatures inside of the hotbox 80. For example, this configuration allows for the use of relatively inexpensive valves, as compared to valves rated for high temperature operation.

The system controller 225 may be configured to control the operation of the valves 316, 318 and/or the recycle blower 121 to control anode exhaust flow to the exhaust processing system 200, the ATO 130, and/or the anode recuperator 110.

For example, during system startup, shutdown, and/or transient operation, the bypass valve 316 may be closed, the return valve 318 may be opened, such that anode exhaust is provided to the ATO 130 generate heat and bring the power module 10 up to the system steady-state operating temperature (e.g., a temperature above 700° C., such as from 750° C. to 900° C.). During the steady-state operation, the bypass valve 316 may be opened and the return valve 318 may be closed, such that all or a majority of the anode exhaust not required for anode recycle is provided to the exhaust processing system 200. In some embodiments, the return valve 318 may be partially opened during steady-state operation, in order to provide the ATO 130 with a relatively reduced amount of anode exhaust to provide additional heat to the system.

In some embodiments, an amount of the anode exhaust that is recycled to the fuel cell column 100 through the fourth recycling conduit 310D, may be at least partially controlled by controlling the speed of the recycle blower 121. Thus, the remaining amount of the anode exhaust that is provided to the exhaust processing system 200 and/or the ATO 130 through the bypass conduit 312 may also be controlled.

The exhaust processing system 200 may be configured to separate carbon dioxide from the anode exhaust in order to generate a commercially valuable carbon dioxide product. The exhaust processing system 200 may also be configured to remove water from the anode exhaust. The exhaust processing system 200 may also include electrochemical pumps and/or distillation systems, to separate other valuable exhaust components, such as hydrogen and/or carbon monoxide. In some embodiments, the exhaust processing system 200 may be configured to receive anode exhaust from multiple hotboxes 80 (e.g., may be connected to multiple power modules 10).

In some embodiments, the amount of H₂ included in the anode exhaust may be increased by lowering the fuel utilization efficiency of the power module 10 below the baseload configuration (e.g., where the power module 10 is configured to operate to meet the electrical power load demand). However, lower fuel utilization efficiencies may lead to a higher output current provided to the load of the power module 10 in order to operate the power module in a thermally stable condition without any fuel being provided to the ATO 130. Lowering the fuel utilization rate may also decrease the AC power efficiency of the power module 10. However, the present inventors have determined that such operation may still be economically advantageous, since a hydrogen (H₂) product is nearly always more valuable than the amount of electricity that could be generated by recycling the H₂ to the power module 10.

The power module 10 may be operated at a fuel cell column fuel utilization rate that is lower than the thermal stability point of the fuel cell column, in order to increase the H₂ content of the anode exhaust. In other words, due to the relatively low fuel utilization rate, the fuel cell columns 100 may generate less heat than required to maintain the fuel cell columns 100 at a desired steady-state operating temperature. For example, the fuel cell columns 100 may have a fuel utilization rate of less than the baseload fuel utilization rate, such as a fuel utilization rate below 85%, such as a fuel utilization rate ranging from about 65% to about 85%, such as from about 70% to about 80%.

In some embodiments, the power module 10 may operate in a start-up mode, and then after reaching a steady-state mode temperature range, the power module 10 may operate in the steady-state mode by repeatedly cycling between an exhaust export mode and a thermal recovery mode, during which the temperature of the fuel cell columns 100 may fluctuate while remaining within a suitable operating temperature range. For example, during the exhaust export mode, all of the anode exhaust may be exported from the power module 10 and provided to the exhaust processing system 200, by opening the bypass valve 316 and closing the ATO valve 318. In other words, no anode exhaust is provided to the ATO 130 during the exhaust export mode and the amount of exported anode exhaust is maximized. During the exhaust export mode, the temperature of the fuel cell columns 100 may drop due to the lower fuel utilization rate of the fuel cell columns 100. For example, in some embodiments, the temperature of the fuel cell columns 100 may be reduced from a first temperature to a lower second temperature, during the exhaust export mode. After the steady-state mode, the power module 10 enters the shut-down mode where its temperature is decreased to room temperature and the power module 10 is shut down.

In some embodiments, the first and second temperatures may be a set maximum fuel cell column operating temperature and a set minimum fuel cell column operating temperature, which may be selected by a system user. The range between the first and second temperatures may be referred to as a “dead band” power module operating temperature range. For example, the fuel cell columns 100 may operate with acceptable efficiency and fuel utilization over a range of operating temperatures. For example, upper and lower limits of an dead band operating temperature range may vary by 20° C., by 15° C., or by 10° C. In some embodiments, the first temperature may range from about 815° C. to about 825° C., such as about 820° C., and the second temperature may range from about 805° C. to about 815° C., such as about 810° C.

Once the column 100 reaches the second temperature, the power module 10 may begin operating in the thermal recovery mode. In particular, the anode exhaust may be provided to the ATO 130 by completely or partially closing the bypass valve 316 and opening the ATO valve 318. The anode exhaust is oxidized in the ATO 130 by the cathode exhaust to heat the fuel cell columns 100. The thermal recovery mode may continue until the fuel cell columns 100 return to the first temperature. The power module 10 may then resume operating in the exhaust export mode, and the cycle may repeat.

In some embodiments, the system controller 225 may be configured to monitor the temperature of the fuel cell columns 100 using one or more thermocouples or other temperature detectors, in order to determine whether the power module 10 should be operated in the exhaust export mode or the thermal recovery mode. In other embodiments, the controller 225 may be configured to periodically switch between the exhaust export and thermal recovery modes. For example, the power module 10 may be operated in the thermal recovery mode for less than 60 seconds (e.g., 5 seconds) every minute, or for less than 10 minutes (e.g., 1 minute) every 10 minutes, in order to maintain the fuel cell columns 100 at a temperature within the dead band operating temperature range.

In embodiments where multiple power modules 10 are connected to the exhaust processing system 200, a substantially uniform amount of anode exhaust may be supplied to the exhaust processing system 200 by operating a consistent number of the power modules 10 in the exhaust export mode. For example, a first power module 10 may be operated in thermal recovery mode, while a remainder of the power modules 10 operate in exhaust export mode. Then a second power module 10 may be operated in thermal recovery mode, while the remainder of the power modules 10 operate in export mode. The process can continue for each power module 10.

Diverting a time dependent portion of the fuel to the ATO 130 may also permit the fuel cell columns 100 to operate at lower currents, which also provides the ability to respond to planned loads as a function of time. This means that the power module 10 can be programmed to run at different power levels at different times of day, at different days of week, during different daily weather forecasts (assuming power required is a function of ambient weather), during different seasons, and/or a combination of one or more of the above. This also allows for a reduction in AC power generation (e.g., from 100% to 60%) by the power modules 10. As a result, various embodiments provide plural (e.g., two) customer specific set points as a function of time to best meet the customers demand by foregoing the traditional practice of optimizing efficiency and fuel utilization for constant baseload electricity production.

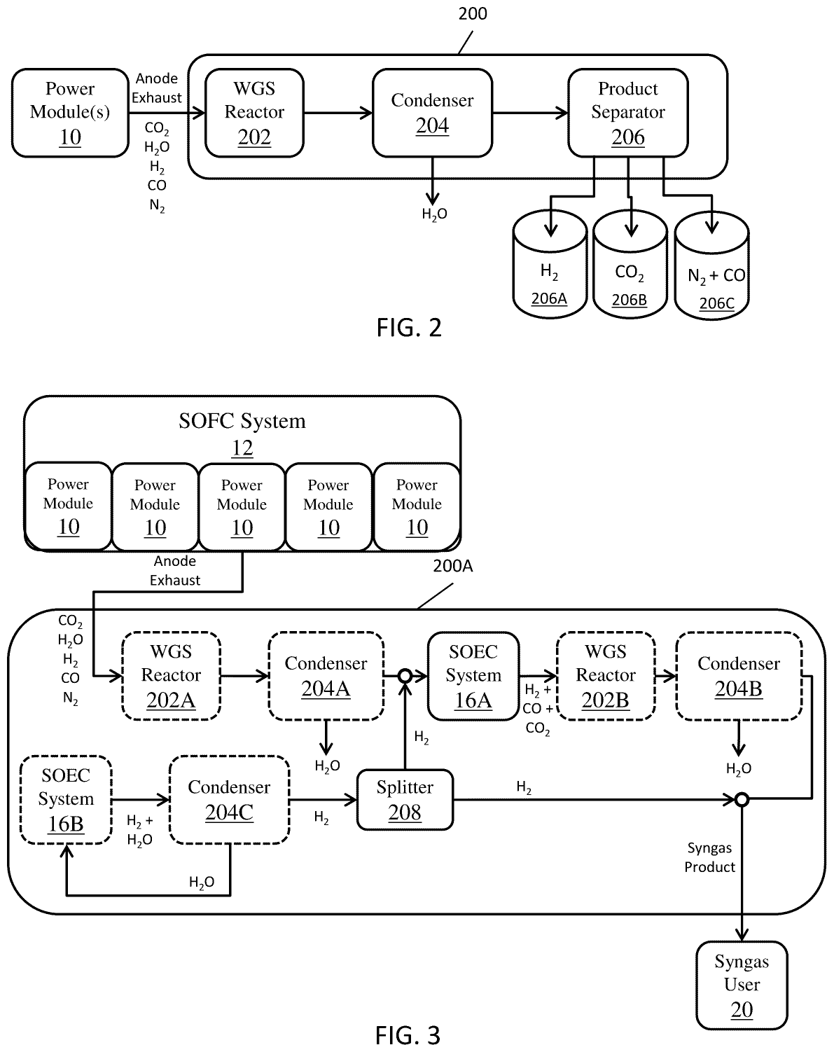

FIG. 2 is a schematic view of an exhaust processing system 200, according to various embodiments of the present disclosure. Referring to FIGS. 1 and 2, the exhaust processing system 200 may include a water gas shift (WGS) reactor 202, a condenser 204, and a product separator 206 that are configured to process anode exhaust received from an SOFC system comprising one or more power modules 10.

According to various embodiments, the present inventors have determined that when a power module 10 is operated at a base operating load of from about 29 to about 50 amps, the power module 10 may have a fuel utilization efficiency of from about 86% to about 88%, without providing any fuel to the ATO 130. Accordingly, the composition of the anode exhaust provided from the SOFC power module 10 may be, by mass, about 39.5% H₂O, about 7.2% CO, about 1.1% H₂, about 0.4% N₂, and about 51.8% CO₂. The anode exhaust may also be free or essentially free of contaminants, such as SOₓ and NOₓ species.

The anode exhaust may be provided to the WGS reactor 202, where CO and water may be reacted to generate additional hydrogen and carbon dioxide in a water-gas shift reaction. For example, a molar composition of the anode exhaust output from the WGS reactor 202 may be, by mass, about 35.7% H₂O, about 1.4% CO, about 1.5% H₂, about 0.4% N₂, and about 61% CO₂.

The anode exhaust may then be provided to the condenser 204, which may be configured to reduce the water content of the anode exhaust, by condensing liquid water out of the anode exhaust stream. For example, a molar composition of the anode exhaust output from the condenser 204 may be, by mass, about 2.2% CO, about 2.3% H₂, about 0.6% N₂, and about 94.9% CO₂.

The anode exhaust may then be provided to the product separator 206. The product separator 206 may be, for example, a cryogenic device or a distillation device configured to separate the anode exhaust into a H₂ product stored in a hydrogen storage vessel 206A, a CO₂ product stored in a carbon dioxide storage vessel 206B, and a remaining product comprising N₂ and CO which may be stored in a remainder vessel 206C or sequestered.

FIG. 3 is a schematic view of an alternative exhaust processing system 200A, according to various embodiments of the present disclosure. Referring to FIGS. 1 and 3, the exhaust processing system 200A may be configured to receive anode exhaust from a fuel cell system (e.g., SOFC system) 12 comprising multiple power modules 10 and provide syngas (e.g., a gas mixture containing hydrogen and carbon monoxide with optional minor additives) to a syngas user 20. A syngas user may comprise any system (e.g., factory), apparatus or method which uses the syngas to generate another product. For example, the syngas user 20 may comprise a system which generates a liquid fuel, such as ethanol, from the syngas. The system may include a reactor containing a catalyst (e.g., Rh—Mn or Cu—Co) which directly catalytically converts the syngas to ethanol in a one step process. Alternatively, the syngas user may comprise a system which generates a liquid fuel, such as ethanol, from the syngas, in a multi-step process. The system may include a reactor containing a catalyst (e.g., Rh—Mn or Cu—Co) which indirectly converts the syngas via methanol or dimethyl ether (DME) synthesis, followed by carbonylation with CO and subsequent hydrogenation of acetic acid or methyl acetate.

For example, the fuel cell system 12 may be configured to meet a significant power demand customer (e.g., a data center or a utility scale power plant) that can be collocated with syngas consuming process, such as a green liquid fuel generation process or any other significant syngas user. Rather than purifying the CO₂ from the anode exhaust product and feeding it to a downstream syngas consuming process, the exhaust processing system 200A may be configured to directly generate syngas from anode exhaust of the power modules 10. The syngas that may be further processed into a desired product.

The exhaust processing system 200A may be configured to adjust the composition of the anode exhaust, based on the requirements of a downstream syngas user 20. In particular, the exhaust processing system 200A may include various components based on the composition of the anode exhaust received from the SOFC system 12. For example, if the anode exhaust has too much fully oxidized content (CO₂ and H₂O instead of CO and H₂), the exhaust processing system 200A may include an electrolyzer system (such as a solid oxide electrolyzer cell (SOEC) system) 16A to convert the CO₂ and H₂O to CO and H₂, thus raising the concentration of the syngas components. The SOEC system 16A may be operated using renewable green power (e.g., solar power, wind power, etc.).

The exhaust processing system 200A may also include an optional WGS reactor 202A and an optional condenser 204A upstream of the SOEC system 16A, with respect to anode exhaust flow direction. In an alternative embodiment, the exhaust processing system 200A may include an optional WGS reactor 202B and an optional condenser 204B downstream of the SOEC system 16A in addition to or instead of the upstream WGS reactor 202A and the upstream condenser 204A. The WGS reactors 202A, 202B may be operated to react the H₂O and CO in the anode exhaust to form additional H₂ and CO₂.

In some embodiments, the exhaust processing system 200A may also include an optional additional SOEC system 16B and condenser 204C configured to provide H₂ to the anode exhaust, upstream and/or downstream of the SOEC system 16A. In particular, the SOEC system 16B and the condenser 204C may be configured to raise the H₂:CO ratio of the anode exhaust provided to the syngas user 20. If the product syngas allows a high enough CO₂+H₂O content, the SOEC systems 16A and/or 16B may be operated without steam recycle in single pass mode. The exhaust processing system 200A may include a splitter 208 to control where the hydrogen generated by the SOEC system 16B is provided to the anode exhaust stream. For example, the splitter 208 may be configured to provide between 0 and 100% of the H₂ generated by the SOEC system 16B upstream of the SOEC system 16A and a remaining amount of the H₂ generated by the SOEC system 16B downstream of the SOEC system 16A.

Fuel utilization in the power modules 10 may be reduced to increase the H₂ and/or CO content of the anode exhaust product, if the content of CO and H₂ of the anode exhaust and the associated value is higher than the marginal value of the electricity at fuel utilization.

In some embodiments, hot anode exhaust (having a temperature of 200° C.-400° C.) can be output from the power modules 10 (depending on requirements) by pulling out some or all of the anode exhaust before it enters the anode exhaust cooler 140 and or before it enters the supplemental anode exhaust cooler 142. This hot anode exhaust may provide multiple benefits, such as allowing for the use of a low temperature WGS reactor to maximize H₂ content. This hot anode exhaust may also have a higher water content, which may increase the H₂ content of the anode exhaust after passing through the SOEC system 16A, and/or may provide a higher temperature feed to the SOEC system 16A, if it does not need to be controlled by a mass flow controller (MFC) based on temperature limitations of an MFC.

The condensers 204A, 204B, if present, may cool the anode exhaust. Water output from the condensers 204A, 204B may be available for use by standard collocated SOEC's, or used on site for cooling tower makeup water if the site has a cooling tower.

Accordingly, the exhaust processing system 200A may provide residual CO and H₂ in the anode exhaust product for use in the downstream syngas consuming process. The first step in the process (reacting CO₂+H₂ to make syngas) is no longer needed. Purification of CO₂ for sequestration or H₂ for sale is no longer required, saving both capital cost and operating parasitic power.

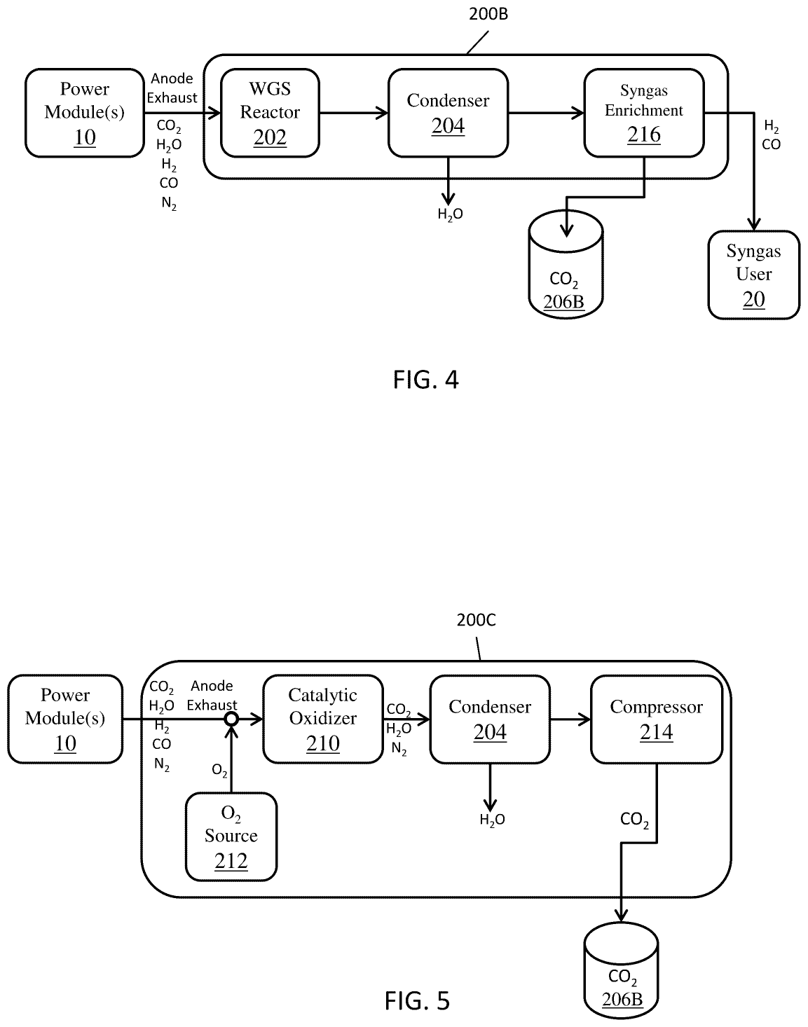

FIG. 4 is a schematic view of an alternative exhaust processing system 200B, according to various embodiments of the present disclosure. Referring to FIGS. 1 and 4, the exhaust processing system 200B may be configured to generate purified CO₂ and syngas using anode exhaust received from one or more power modules 10.

In particular, the exhaust processing system 200B may include a WGS reactor 202, a condenser 204, and a syngas enrichment system 216. The WGS reactor 202 may be used to increase the H₂ and CO₂ content of the anode exhaust. The anode exhaust may be partially or completely dehydrated.

The anode exhaust may then be provided to the syngas enrichment system 216 configured to generate syngas of a desired H₂ and CO content. For example, the enrichment system 216 may include a cryogenic process, a pressure swing adsorption process, a membrane process, an amine-based absorber/stripper process, or the like configured to adjust the composition of the anode exhaust. For example, all or a portion of the CO₂ component of the anode exhaust may be separated from the syngas component and stored in storage vessel 206B. In addition, the syngas enrichment system 216 may be configured to adjust the H₂ to CO ratio of the anode exhaust to match the requirements of the syngas user 20.

The final syngas product may be provided to a syngas user 20, such as a manufacturing process in a factory that uses syngas to produce a carbon neutral product (e.g. ethanol, other liquid fuels, etc.). H₂ from the above described electrolyzer system(s) may be added to increase the H₂/CO ratio of the final syngas fed to the syngas user 20.

FIG. 5 is a schematic view of an alternative exhaust processing system 200C, according to various embodiments of the present disclosure. Referring to FIGS. 1 and 5, the exhaust processing system 200C may be configured to reduce the CO content of anode exhaust received from one or more power modules 10. In particular, a high CO concentration may complicate the processing of anode exhaust.

Accordingly, the exhaust processing system 200C may include a catalytic oxidizer 210, an oxygen (e.g., O₂) source 212, a condenser 204, and a compressor 214. The oxidizer 210 may be configured to oxidize the anode exhaust received from one or more power modules 10. In particular, the oxidizer 210 may include a reaction zone configured to oxidize CO and H₂ to generate CO₂ and H₂O. The oxidizer 210 may also include an oxidation catalyst disposed downstream of the reaction zone and configured to promote the oxidation of any remaining oxidizable species. The oxidized anode exhaust output from the oxidizer 210 may contain primarily CO₂ and H₂O, with a trace amount of contaminants such as N₂ and/or O₂.

The O₂ source 212 may be configured to supply an oxygen stream to an anode exhaust stream provided to the catalytic oxidizer 210. In some embodiments, the O₂ source 212 may include an oxygen generator and/or an O₂ storage tank to ensure a consistent supply of oxygen to the catalytic oxidizer 210. Alternatively, if the SOEC system 16B shown in FIG. 3 is used in the system shown in FIG. 5, then the O₂ source 212 may comprise the enriched air exhaust of the SOEC system 16B. The purity of the oxygen stream provided by the O₂ source 212 may be selected to minimize oxygen stream generation costs, while limiting the amounts of N₂ and/or Ar that are present in the oxygen stream. For example, the O₂ source 212 may extract oxygen from air, and thus, trace amounts of N₂ and/or Ar may be present in the extracted oxygen. In various embodiments, the oxygen stream may have a molar amount of O₂ ranging from about 95% to about 99.8%. The flowrate of the oxygen stream may be set to provide a slight stoichiometric excess of O₂, a stoichiometric amount of O₂, or a sub-stoichiometric amount of O₂, depending on acceptable amounts of CO, H₂, O₂ and/or other diluents in a carbon dioxide product output from the exhaust processor 200B.

The condenser 204 may be configured to remove water from oxidized anode exhaust output from the catalytic oxidizer 210. The compressor 214 may be configured to compress the dried anode exhaust output from the condenser 204. In some embodiments, the compressor 214 may include or be substituted for a dehydrator. The compressed anode exhaust may comprise at least about 95 mol % CO₂.

The combustion exotherm can be approximately 1000° C. (as a temperature increase from the combustion feed temperature, assuming the anode exhaust composition is based on 86% fuel utilization). This may utilize breaking the oxidation into multiple stages, with inter-stage cooling.

In some embodiments, heat may be recovered from the power modules 10, the oxidizer 210, the condenser, and or the compressor 214 and utilized on site. For example, the recovered heat may be utilized in a combined heat and power system. For example, the recovered heat may be utilized for water heating, hot oil heating, steam generation, steam superheating, or any combination thereof.

Fuel cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A method of operating a fuel cell system, comprising:
operating the fuel cell system in a start-up mode; and
operating the fuel cell system in a steady state mode after the step of operating the fuel cell system in the start-up mode, wherein during the step of operating the fuel cell system in the steady-state mode, the fuel cell system cycles between operating in an exhaust export mode and in a thermal recovery mode a plurality of times,
wherein:
during the exhaust export mode, an anode exhaust generated by fuel cells of the fuel cell system is provided to an exhaust processing system, and no anode exhaust is provided to an anode tailgas oxidizer (ATO); and
during the thermal recovery mode, at least a portion of the anode exhaust is provided to the ATO.

2. The method of claim 1, wherein during the thermal recovery mode, all of the anode exhaust is provided to the ATO, and none of the anode exhaust is provided to the exhaust processing system.

3. The method of claim 1, wherein the fuel cells are arranged in a fuel cell column.

4. The method of claim 3, wherein:
during the exhaust export mode, a temperature of the fuel cell column decreases from a first temperature to a second temperature which is at least 10° C. lower than the first temperature; and
during the thermal recovery mode, oxidation of the anode exhaust in the ATO heats the fuel cell column, and the temperature of the column increases from the second temperature to the first temperature.

5. The method of claim 4, wherein the fuel cell system cycles between the exhaust export mode and the thermal recovery mode based on a fixed time cycle.

6. The method of claim 4, wherein the fuel cell system cycles between the exhaust export mode and the thermal recovery mode based on a detected temperature of the fuel cell column.

7. The method of claim 6, further comprising:
switching from the exhaust export mode to the thermal recovery mode after the temperature of the fuel cell column is reduced to the second temperature during the exhaust export mode; and
switching from the thermal recovery mode to the exhaust export mode after the temperature of the fuel cell column is increased from the second temperature to the first temperature during the thermal recovery mode.

8. The method of claim 3, wherein:
the fuel cells comprise solid oxide fuel cells; and
the fuel utilization rate of the fuel cell column is less than 85% during both the thermal recovery mode and the exhaust export mode.

9. The method of claim 1, further comprising using a first electrolyzer system of the exhaust processor to electrolyze water and carbon dioxide present in the anode exhaust and to output the anode exhaust having an increased hydrogen and carbon monoxide content.

10. The method of claim 9, further comprising supplying hydrogen from a second electrolyzer system to the anode exhaust to increase the hydrogen content of the anode exhaust.

11. The method of claim 9, further comprising:
using a water gas shift (WGS) reactor of the exhaust processor to increase the hydrogen and carbon monoxide content of the anode exhaust; and
using a condenser of the anode exhaust processor to reduce a water content of the anode exhaust output from the WGS reactor.

12. The method of claim 1, further comprising:
separating water and carbon dioxide in the anode exhaust from syngas consisting essentially of a mixture of hydrogen and carbon monoxide; and
providing the syngas to a syngas user.

13. A method, comprising:
operating a fuel cell system to generate power and an anode exhaust;
separating water and carbon dioxide in the anode exhaust from syngas consisting essentially of a mixture of hydrogen and carbon monoxide; and
providing the syngas to a syngas user.

14. The method of claim 13, further comprising providing the anode exhaust to a first electrolyzer system to increase a content of the hydrogen and the carbon monoxide of the anode exhaust by electrolyzing water and carbon dioxide present in the anode exhaust.

15. The method of claim 14, further comprising:
generating additional hydrogen by electrolyzing water in a second electrolyzer system; and
providing the additional hydrogen to the anode exhaust or to the syngas.

16. The method of claim 13, further comprising reducing a water content of the anode exhaust or the syngas.

17. The method of claim 13, further comprising using a water gas shift (WGS) reactor to increase a content of the hydrogen and carbon monoxide of the anode exhaust.

18. The method of claim 13, further comprising producing a liquid fuel using the syngas at the syngas user.

19. The method of claim 13, wherein the fuel cell system comprises a solid oxide fuel cell system.

20. An apparatus, comprising:
a fuel cell system;
an exhaust processing system; and
at least one anode exhaust conduit fluidly connecting an anode exhaust of the fuel cell system to an inlet of the exhaust processing system,
wherein the exhaust processing system is configured to separate water and carbon dioxide in an anode exhaust of the fuel cell system from syngas consisting essentially of a mixture of hydrogen and carbon monoxide, and to provide the syngas to a syngas user.
